(19) United States
(12) Patent Application Publication
(10) Pub. No.: US 2017/0202030 A1
(43) Pub. Date: Jul. 13, 2017

(54) Random Access Method, Network Device, and User Equipment

(71) Applicant: Huawei Technologies Co., Ltd., Shenzhen (CN)

(72) Inventors: Song Zhu, Beijing (CN); Juan Wang, Shenzhen (CN)

(21) Appl. No.: 15/468,599

(22) Filed: Mar. 24, 2017

Related U.S. Application Data
(63) Continuation of application No. PCT/CN2014/087455, filed on Sep. 25, 2014.

(51) Int. Cl. H04W 74/08; H04W 48/08

(52) U.S. Cl. CPC H04W 74/0833; H04W 48/08

(57) ABSTRACT

Embodiments provide a random access method, a network device, and user equipment. The method includes receiving, by a network device, identification information sent by user equipment UE according to an access status, and allocating, by the network device, a first access network identifier to the UE according to the identification information. The method also includes sending, by the network device, the first access network identifier to the UE, and allocating, by the network device, a resource to the UE according to the first access network identifier.

### CROSS-REFERENCE TO RELATED APPLICATIONS

This application is continuation of International Application No. PCT/CN2014/087455, filed on Sep. 25, 2014, the disclosure of which is hereby incorporated by reference in its entirety.

### TECHNICAL FIELD

Embodiments of the present invention relate to the communications technologies, and in particular, to a random access method, a network device, and user equipment.

### BACKGROUND

In a wireless communications system, before exchanging data with a network side device, a terminal needs to establish a wireless connection with the network side device by using a random access (RA) process, so that the terminal and the network side device are in a connected state, and then, the terminal establishes a data communication connection with the network side device.

In the prior art, a terminal mostly accesses a network side device in a preamble sequence manner by using a random access process. Actually, the preamble sequence manner is as follows: The network side device feeds back a response message to the terminal after receiving a preamble sequence sent by the terminal, and the terminal sends a random access message or a resource request message to the network side device after receiving the response message, so that the network side device allocates a dedicated resource to the terminal.

However, because the preamble sequence is actually multiple times of repetition of a feature code selected by the terminal, the preamble sequence occupies a relatively large quantity of bits. Consequently, a relatively large quantity of resources are used for random access that is based on the preamble sequence manner, and signaling overheads are high.

### SUMMARY

Embodiments of the present invention provide a random access method, a network device, and user equipment, to resolve existing problems that a relatively large quantity of resources are used for random access and signaling overheads are high.

According to a first aspect, an embodiment of the present invention provides a random access method. The method includes receiving, by a network device, identification information sent by user equipment UE according to an access status. The method also includes allocating, by the network device, a first access network identifier to the UE according to the identification information. The method also includes sending, by the network device, the first access network identifier to the UE. The method also includes allocating, by the network device, a resource to the UE according to the first access network identifier.

According to the first aspect, in a first possible implementation manner of the first aspect, the receiving, by a network device, identification information sent by UE according to an access status includes receiving, by the network device, the identification information sent by the UE according to the access status by using an uplink channel resource.

According to the first possible implementation manner of the first aspect, in a second possible implementation manner, the uplink channel resource includes a time-frequency resource used for random access.

According to the first or the second possible implementation manner of the first aspect, in a third possible implementation manner, the method further includes: receiving, by the network device, buffer status report BSR information sent by the UE by using the uplink channel resource, where the BSR information includes a size of to-be-sent data of the UE; and correspondingly, the allocating, by the network device, a first access network identifier to the UE according to the identification information includes: allocating, by the network device, the first access network identifier to the UE according to the identification information and the BSR information.

According to any one of the first to the third possible implementation manners of the first aspect, in a fourth possible implementation manner, the method further includes receiving, by the network device, connection establishment cause information sent by the UE by using the uplink channel resource.

According to any one of the first aspect to the fourth possible implementation manner of the first aspect, in a fifth possible implementation manner, the first access network identifier includes a cell radio network temporary identifier C-RNTI.

According to any one of the first aspect to the fifth possible implementation manner of the first aspect, in a sixth possible implementation manner, the sending, by the network device, the first access network identifier to the UE includes sending, by the network device, the first access network identifier and the identification information to the UE by using a physical downlink shared channel PDSCH, where the identification information is used for the UE to determine the first access network identifier from the PDSCH.

According to the sixth possible implementation manner of the first aspect, in a seventh possible implementation manner, the method further includes sending, by the network device, scheduling information of the PDSCH to the UE by using downlink control information DCI, where the scheduling information includes a time-frequency resource location corresponding to the UE, and the time-frequency resource location corresponding to the UE is used for the UE to determine the first access network identifier from the PDSCH with reference to the identification information.

According to any one of the first aspect to the seventh possible implementation manner of the first aspect, in an eighth possible implementation manner, if no access network identifier or core network identifier is allocated to the UE, or an identifier already allocated to the UE is invalid, the identification information includes a string of random numbers selected by the UE.

According to any one of the first aspect to the seventh possible implementation manner of the first aspect, in a ninth possible implementation manner, if the UE is in an idle state, and a core network identifier has already been allocated to the UE, the identification information includes the core network identifier of the UE.

According to the ninth possible implementation manner of the first aspect, in a tenth possible implementation manner, the core network identifier of the UE includes a temporary mobile subscriber identity allocated by a mobility management entity MME to the UE.

According to any one of the first aspect to the fifth possible implementation manner of the first aspect, in an eleventh possible implementation manner, if a second access network identifier has already been allocated to the UE, the identification information includes the second access network identifier, where the second access network identifier is a C-RNTI; before the allocating, by the network device, a first access network identifier to the UE according to the identification information, the method further includes: determining, by the network device, whether the second access network identifier is used; and correspondingly, the allocating, by the network device, a first access network identifier to the UE according to the identification information includes: if the second access network identifier is used, allocating, by the network device, the first access network identifier to the UE.

According to the eleventh possible implementation manner of the first aspect, in a twelfth possible implementation manner, the sending, by the network device, the first access network identifier to the UE includes: scheduling, by the network device, a downlink channel resource by using a random access radio network temporary identifier RA-RNTI corresponding to a time-frequency location of the uplink channel resource, and sending the first access network identifier and the second access network identifier to the UE by using the downlink channel resource.

According to the eleventh possible implementation manner of the first aspect, in a thirteenth possible implementation manner, the sending, by the network device, the first access network identifier to the UE includes: scheduling, by the network device, a downlink channel resource by using the second access network identifier, and sending the first access network identifier to the UE by using the downlink channel resource.

According to any one of the eleventh to the thirteenth possible implementation manners of the first aspect, in a fourteenth possible implementation manner, the method further includes: if the second access network identifier is not used, allocating, by the network device, a resource to the UE according to the second access network identifier.

According to any one of the first aspect to the fifth possible implementation manner of the first aspect, in a fifteenth possible implementation manner, if a cell handover is performed on the UE, and a third access network identifier has already been allocated to the UE, the identification information includes the third access network identifier, where the third access network identifier includes an identifier allocated to the UE by a network device in another cell except a cell in which the network device is located; before the allocating, by the network device, a first access network identifier to the UE according to the identification information, the method further includes: determining, by the network device, whether the third access network identifier is used; and correspondingly, the sending, by the network device, the first access network identifier to the UE includes: sending, by the network device, the first access network identifier to the UE in different manners according to different determining results of the third access network identifier.

According to the fifteenth possible implementation manner of the first aspect, in a sixteenth possible implementation manner, the sending, by the network device, the first access network identifier to the UE in different manners according to different determining results of the third access network identifier includes: if the third access network identifier is used, scheduling, by the network device, a downlink channel resource by using an RA-RNTI corresponding to a time-frequency location of the uplink channel resource, and sending the first access network identifier to the UE by using the downlink channel resource.

According to the fifteenth possible implementation manner of the first aspect, in a seventeenth possible implementation manner, the sending, by the network device, the first access network identifier to the UE in different manners according to different determining results of the third access network identifier includes: if the third access network identifier is not used, scheduling, by the network device, a downlink channel resource by using the third access network identifier, and sending the first access network identifier to the UE by using the downlink channel resource.

According to a second aspect, an embodiment of the present invention provides a random access method. The method includes sending, by UE, identification information to a network device according to an access status. The method also includes receiving, by the UE, a first access network identifier sent by the network device, where the first access network identifier is an access network identifier allocated by the network device to the UE according to the identification information, and the first access network identifier is used for the network device to allocate a resource to the UE.

According to the second aspect, in a first possible implementation manner of the second aspect, the sending, by UE, identification information to a network device according to an access status includes: sending, by the UE, the identification information to the network device according to the access status by using an uplink channel resource.

According to the first possible implementation manner of the second aspect, in a second possible implementation manner, the uplink channel resource includes a time-frequency resource used for random access.

According to the first or the second possible implementation manner of the second aspect, in a third possible implementation manner, the method further includes: sending, by the UE, BSR information to the network device by using the uplink channel resource, where the BSR information is used for the network device to allocate the first access network identifier to the UE with reference to the identification information, and the BSR information includes a size of to-be-sent data of the UE.

According to any one of the first to the third possible implementation manners of the second aspect, in a fourth possible implementation manner, the method further includes: sending, by the UE, connection establishment cause information to the network device by using the uplink channel resource.

According to any one of the second aspect to the fourth possible implementation manner of the second aspect, in a fifth possible implementation manner, the first access network identifier includes a C-RNTI.

According to any one of the second aspect to the fifth possible implementation manner of the second aspect, in a sixth possible implementation manner, the receiving, by the UE, a first access network identifier sent by the network device includes: receiving, by the UE, the first access network identifier and the identification information that are sent by the network device by using the PDSCH; and determining, by the UE, the first access network identifier from the PDSCH according to the identification information.

According to the sixth possible implementation manner of the second aspect, in a seventh possible implementation manner, before the determining, by the UE, the first access network identifier from the PDSCH according to the identification information, the method further includes: receiving, by the UE, scheduling information that is of the PDSCH and is sent by the network device by using DCI, where the scheduling information includes a time-frequency resource location corresponding to the UE; and correspondingly, the determining, by the UE, the first access network identifier from the PDSCH according to the identification information includes: determining, by the UE, the first access network identifier from the PDSCH according to the identification information and the time-frequency resource location corresponding to the UE.

According to any one of the second aspect to the seventh possible implementation manner of the second aspect, in an eighth possible implementation manner, if no access network identifier or core network identifier is allocated to the UE, or an identifier already allocated to the UE is invalid, the identification information includes a string of random numbers selected by the UE.

According to any one of the second aspect to the seventh possible implementation manner of the second aspect, in a ninth possible implementation manner, if the UE is in an idle state, and a core network identifier has already been allocated to the UE, the identification information includes the core network identifier of the UE.

According to the ninth possible implementation manner of the second aspect, in a tenth possible implementation manner, the core network identifier of the UE includes a temporary mobile subscriber identity allocated by an MME to the UE.

According to any one of the second aspect to the fifth possible implementation manner of the second aspect, in an eleventh possible implementation manner, if a second access network identifier has already been allocated to the UE, and the second access network identifier is not used, the identification information includes the second access network identifier, where the second access network identifier is a C-RNTI.

According to the eleventh possible implementation manner of the second aspect, in a twelfth possible implementation manner, the receiving, by the UE, a first access network identifier sent by the network device includes: receiving, by the UE, the first access network identifier and the second access network identifier that are sent by the network device by using a downlink channel resource scheduled by using an RA-RNTI corresponding to a time-frequency location of the uplink channel resource.

According to the eleventh possible implementation manner of the second aspect, in a thirteenth possible implementation manner, the receiving, by the UE, a first access network identifier sent by the network device includes: receiving, by the UE, the first access network identifier sent by the network device by using a downlink channel resource scheduled by using the second access network identifier.

According to any one of the second aspect to the fifth possible implementation manner of the second aspect, in a fourteenth possible implementation manner, if a cell handover is performed on the UE, and a third access network identifier has already been allocated to the UE, the identification information includes the third access network identifier, where the third access network identifier includes an identifier allocated to the UE by a network device in another cell except a cell in which the network device is located; and the receiving, by the UE, a first access network identifier sent by the network device includes: receiving, by the UE, the first access network identifier sent by the network device in different manners according to different determining results of the third access network identifier.

According to the fourteenth possible implementation manner of the second aspect, in a fifteenth possible implementation manner, the receiving, by the UE, the first access network identifier sent by the network device in different manners according to different determining results of the third access network identifier includes: receiving, by the UE, the first access network identifier sent, when the third access network identifier is used, by the network device by using a downlink channel resource scheduled by using an RA-RNTI corresponding to a time-frequency location of the uplink channel resource.

According to the fourteenth possible implementation manner of the second aspect, in a sixteenth possible implementation manner, the receiving, by the UE, the first access network identifier sent by the network device in different manners according to different determining results of the third access network identifier includes: receiving, by the UE, the first access network identifier sent, when the third access network identifier is not used, by the network device by using a downlink channel resource scheduled by using the third access network identifier.

According to a third aspect, an embodiment of the present invention provides a network device. The device includes a receiving module, an allocation module, and a sending module, where the receiving module, the allocation module, and the sending module are successively connected. The receiving module is configured to: receive identification information sent by UE according to an access status, and send the identification information to the allocation module. The allocation module is configured to: allocate a first access network identifier to the UE according to the identification information, and send the first access network identifier to the sending module. The sending module is configured to send the first access network identifier to the UE. The allocation module is further configured to allocate a resource to the UE according to the first access network identifier.

According to the third aspect, in a first possible implementation manner of the third aspect, the receiving module is further configured to receive the identification information sent by the UE according to the access status by using an uplink channel resource.

According to the first possible implementation manner of the third aspect, in a second possible implementation manner, the uplink channel resource includes a time-frequency resource used for random access.

According to the first or the second possible implementation manner of the third aspect, in a third possible implementation manner, the receiving module is further configured to: receive BSR information sent by the UE by using the uplink channel resource, and send the BSR information to the allocation module, where the BSR information includes a size of to-be-sent data of the UE; and correspondingly, the allocation module is further configured to allocate the first access network identifier to the UE according to the identification information and the BSR information.

According to any one of the first to the third possible implementation manners of the third aspect, in a fourth possible implementation manner, the receiving module is further configured to receive connection establishment cause information sent by the UE by using the uplink channel resource.

According to any one of the third aspect to the fourth possible implementation manner of the third aspect, in a fifth possible implementation manner, the first access network identifier includes a C-RNTI.

According to any one of the third aspect to the fifth possible implementation manner of the third aspect, in a sixth possible implementation manner, the sending module is further configured to send the first access network identifier and the identification information to the UE by using a PDSCH, where the identification information is used for the UE to determine the first access network identifier from the PDSCH.

According to the sixth possible implementation manner of the third aspect, in a seventh possible implementation manner, the sending module is further configured to send scheduling information of the PDSCH to the UE by using DCI, where the scheduling information includes a time-frequency resource location corresponding to the UE, and the time-frequency resource location corresponding to the UE is used for the UE to determine the first access network identifier from the PDSCH with reference to the identification information.

According to any one of the third aspect to the seventh possible implementation manner of the third aspect, in an eighth possible implementation manner, if no access network identifier or core network identifier is allocated to the UE, or an identifier already allocated to the UE is invalid, the identification information received by the receiving module includes a string of random numbers selected by the UE.

According to any one of the third aspect to the seventh possible implementation manner of the third aspect, in a ninth possible implementation manner, if the UE is in an idle state, and a core network identifier has already been allocated to the UE, the identification information received by the receiving module includes the core network identifier of the UE.

According to the ninth possible implementation manner of the third aspect, in a tenth possible implementation manner, the core network identifier of the UE includes a temporary mobile subscriber identity allocated by an MME to the UE.

According to any one of the third aspect to the fifth possible implementation manner of the third aspect, in an eleventh possible implementation manner, if a second access network identifier has already been allocated to the UE, the identification information received by the receiving module includes the second access network identifier, where the second access network identifier is a C-RNTI; the network device further includes a first determining module, and the first determining module is connected to the receiving module and the allocation module; the first determining module is configured to: before the allocation module allocates the first access network identifier to the UE according to the identification information, determine whether the second access network identifier is used, and send a determining result of the second access network identifier to the allocation module; and correspondingly, the allocation module is further configured to: if the second access network identifier is used, allocate the first access network identifier to the UE.

According to the eleventh possible implementation manner of the third aspect, in a twelfth possible implementation manner, the network device further includes a first scheduling module, and the first scheduling module is connected to the allocation module and the sending module; the first scheduling module is configured to schedule a downlink channel resource by using an RA-RNTI corresponding to a time-frequency location of the uplink channel resource; and the sending module is further configured to send the first access network identifier and the second access network identifier to the UE by using the downlink channel resource.

According to the eleventh possible implementation manner of the third aspect, in a thirteenth possible implementation manner, the network device further includes a second scheduling module, and the second scheduling module is connected to the allocation module and the sending module; the second scheduling module is configured to schedule a downlink channel resource by using the second access network identifier; and the sending module is further configured to send the first access network identifier to the UE by using the downlink channel resource.

According to any one of the eleventh to the thirteenth possible implementation manners of the third aspect, in a fourteenth possible implementation manner, the allocation module is further configured to: if the second access network identifier is not used, allocate a resource to the UE according to the second access network identifier.

According to any one of the third aspect to the fifth possible implementation manner of the third aspect, in a fifteenth possible implementation manner, if a cell handover is performed on the UE, and a third access network identifier has already been allocated to the UE, the identification information received by the receiving module includes the third access network identifier, where the third access network identifier includes an identifier allocated to the UE by a network device in another cell except a cell in which the network device is located; the network device further includes a second determining module, and the second determining module is connected to the receiving module and the allocation module; the second determining module is configured to: before the allocation module allocates the first access network identifier to the UE according to the identification information, determine whether the third access network identifier is used, and send a determining result of the third access network identifier to the allocation module; and correspondingly, the sending module is further configured to send the first access network identifier to the UE in different manners according to different determining results of the third access network identifier.

According to the fifteenth possible implementation manner of the third aspect, in a sixteenth possible implementation manner, the network device further includes a third scheduling module, and the third scheduling module is connected to the allocation module and the sending module; the third scheduling module is configured to: if the third access network identifier is used, schedule a downlink channel resource by using an RA-RNTI corresponding to a time-frequency location of the uplink channel resource; and the sending module is further configured to send the first access network identifier to the UE by using the downlink channel resource.

According to the fifteenth possible implementation manner of the third aspect, in a seventeenth possible implementation manner, the network device further includes a fourth scheduling module, and the fourth scheduling module is connected to the allocation module and the sending module; the fourth scheduling module is configured to: if the third access network identifier is not used, schedule a downlink channel resource by using the third access network identifier; and the sending module is further configured to send the first access network identifier to the UE by using the downlink channel resource.

According to a fourth aspect, an embodiment of the present invention further provides UE, including a sending module and a receiving module, where the sending module and the receiving module are connected; the sending module is configured to send identification information to a network device according to an access status; and the receiving module is configured to receive a first access network identifier sent by the network device, where the first access network identifier is an access network identifier allocated by the network device to the UE according to the identification information, and the first access network identifier is used for the network device to allocate a resource to the UE.

According to the fourth aspect, in a first possible implementation manner, the sending module is further configured to send the identification information to the network device according to the access status by using an uplink channel resource.

According to the first possible implementation manner of the fourth aspect, in a second possible implementation manner, the uplink channel resource includes a time-frequency resource used for random access.

According to the first or the second possible implementation manner of the fourth aspect, in a third possible implementation manner, the sending module is further configured to send BSR information to the network device by using the uplink channel resource, where the BSR information is used for the network device to allocate the first access network identifier to the UE with reference to the identification information, and the BSR information includes a size of to-be-sent data of the UE.

According to any one of the first to the third possible implementation manners of the fourth aspect, in a fourth possible implementation manner, the sending module is further configured to send connection establishment cause information to the network device by using the uplink channel resource.

According to any one of the fourth aspect to the fourth possible implementation manner of the fourth aspect, in a fifth possible implementation manner, the first access network identifier received by the receiving module includes a C-RNTI.

According to any one of the fourth aspect to the fifth possible implementation manner of the fourth aspect, in a sixth possible implementation manner, the UE further includes a determining module, and the determining module and the receiving module are connected; and the receiving module is further configured to: receive the first access network identifier and the identification information that are sent by the network device by using the PDSCH, and send the PDSCH and the identification information to the determining module. The determining module is configured to determine the first access network identifier from the PDSCH according to the identification information.

According to the sixth possible implementation manner of the fourth aspect, in a seventh possible implementation manner, the receiving module is further configured to: before the determining module determines the first access network identifier from the PDSCH, receive scheduling information that is of the PDSCH and is sent by the network device by using DCI, and send the scheduling information to the determining module, where the scheduling information includes a time-frequency resource location corresponding to the UE; and the determining module is further configured to determine the first access network identifier from the PDSCH according to the identification information and the time-frequency resource location corresponding to the UE.

According to any one of the fourth aspect to the seventh possible implementation manner of the fourth aspect, in an eighth possible implementation manner, if no access network identifier or core network identifier is allocated to the UE, or an identifier already allocated to the UE is invalid, the identification information includes a string of random numbers selected by the UE.

According to any one of the fourth aspect to the seventh possible implementation manner of the fourth aspect, in a ninth possible implementation manner, if the UE is in an idle state, and a core network identifier has already been allocated to the UE, the identification information includes the core network identifier of the UE.

According to the ninth possible implementation manner of the fourth aspect, in a tenth possible implementation manner, the core network identifier of the UE includes a temporary mobile subscriber identity allocated by an MME to the UE.

According to any one of the fourth aspect to the fifth possible implementation manner of the fourth aspect, in an eleventh possible implementation manner, if a second access network identifier has already been allocated to the UE, and the second access network identifier is not used, the identification information includes the second access network identifier, where the second access network identifier is a C-RNTI.

According to the eleventh possible implementation manner of the fourth aspect, in a twelfth possible implementation manner, the receiving module is further configured to receive the first access network identifier and the second access network identifier that are sent by the network device by using a downlink channel resource scheduled by using an RA-RNTI corresponding to a time-frequency location of the uplink channel resource.

According to the eleventh possible implementation manner of the fourth aspect, in a thirteenth possible implementation manner, the receiving module is further configured to receive the first access network identifier sent by the network device by using a downlink channel resource scheduled by using the second access network identifier.

According to any one of the fourth aspect to the fifth possible implementation manner of the fourth aspect, in a fourteenth possible implementation manner, if a cell handover is performed on the UE, and a third access network identifier has already been allocated to the UE, the identification information includes the third access network identifier, where the third access network identifier includes an identifier allocated to the UE by a network device in another cell except a cell in which the network device is located; and the receiving module is further configured to receive the first access network identifier sent by the network device in different manners according to different determining results of the third access network identifier.

According to the fourteenth possible implementation manner of the fourth aspect, in a fifteenth possible implementation manner, the receiving module is further configured to receive the first access network identifier sent, when the third access network identifier is used, by the network device by using a downlink channel resource scheduled by using an RA-RNTI corresponding to a time-frequency location of the uplink channel resource.

According to the fourteenth possible implementation manner of the fourth aspect, in a sixteenth possible implementation manner, the receiving module is further configured to receive the first access network identifier sent, when the third access network identifier is not used, by the network device by using a downlink channel resource scheduled by using the third access network identifier.

According to a fifth aspect, an embodiment of the present invention further provides a network device, including a receiver, a processor, and a transmitter. The receiver, the processor, and the transmitter are successively connected. The receiver is configured to: receive identification information sent by UE according to an access status, and send the identification information to the processor. The processor is configured to: allocate a first access network identifier to the UE according to the identification information, and send the first access network identifier to the transmitter. The transmitter is configured to send the first access network identifier to the UE. The processor is further configured to allocate a resource to the UE according to the first access network identifier.

According to the fifth aspect, in a first possible implementation manner of the fifth aspect, the receiver is further configured to receive the identification information sent by the UE according to the access status by using an uplink channel resource.

According to the first possible implementation manner of the fifth aspect, in a second possible implementation manner, the uplink channel resource includes a time-frequency resource used for random access.

According to the first or the second possible implementation manner of the fifth aspect, in a third possible implementation manner, the receiver is further configured to: receive BSR information sent by the UE by using the uplink channel resource, and send the BSR information to the processor, where the BSR information includes a size of to-be-sent data of the UE. Correspondingly, the processor is further configured to allocate the first access network identifier to the UE according to the identification information and the BSR information.

According to any one of the first to the third possible implementation manners of the fifth aspect, in a fourth possible implementation manner, the receiver is further configured to receive connection establishment cause information sent by the UE by using the uplink channel resource.

According to any one of the fifth aspect to the fourth possible implementation manner of the fifth aspect, in a fifth possible implementation manner, the first access network identifier includes a C-RNTI.

According to any one of the fifth aspect to the fifth possible implementation manner of the fifth aspect, in a sixth possible implementation manner, the transmitter is further configured to send the first access network identifier and the identification information to the UE by using a PDSCH, where the identification information is used for the UE to determine the first access network identifier from the PDSCH.

According to the sixth possible implementation manner of the fifth aspect, in a seventh possible implementation manner, the transmitter is further configured to send scheduling information of the PDSCH to the UE by using DCI, where the scheduling information includes a time-frequency resource location corresponding to the UE, and the time-frequency resource location corresponding to the UE is used for the UE to determine the first access network identifier from the PDSCH with reference to the identification information.

According to any one of the fifth aspect to the seventh possible implementation manner of the fifth aspect, in an eighth possible implementation manner, if no access network identifier or core network identifier is allocated to the UE, or an identifier already allocated to the UE is invalid, the identification information received by the receiver includes a string of random numbers selected by the UE.

According to any one of the fifth aspect to the seventh possible implementation manner of the fifth aspect, in a ninth possible implementation manner, if the UE is in an idle state, and a core network identifier has already been allocated to the UE, the identification information received by the receiver includes the core network identifier of the UE.

According to the ninth possible implementation manner of the fifth aspect, in a tenth possible implementation manner, the core network identifier of the UE includes a temporary mobile subscriber identity allocated by an MME to the UE.

According to any one of the fifth aspect to the fifth possible implementation manner of the fifth aspect, in an eleventh possible implementation manner, if a second access network identifier has already been allocated to the UE, the identification information received by the receiver includes the second access network identifier, where the second access network identifier is a C-RNTI. The processor is further configured to: before allocating the first access network identifier to the UE according to the identification information, determine whether the second access network identifier is used, and if the second access network identifier is used, allocate the first access network identifier to the UE.

According to the eleventh possible implementation manner of the fifth aspect, in a twelfth possible implementation manner, the processor is further configured to schedule a downlink channel resource by using an RA-RNTI corresponding to a time-frequency location of the uplink channel resource. The transmitter is further configured to send the first access network identifier and the second access network identifier to the UE by using the downlink channel resource.

According to the eleventh possible implementation manner of the fifth aspect, in a thirteenth possible implementation manner, the processor is further configured to schedule a downlink channel resource by using the second access network identifier. The transmitter is further configured to send the first access network identifier to the UE by using the downlink channel resource.

According to any one of the eleventh to the thirteenth possible implementation manners of the fifth aspect, in a fourteenth possible implementation manner, the processor is further configured to: if the second access network identifier is not used, allocate a resource to the UE according to the second access network identifier.

According to any one of the fifth aspect to the fifth possible implementation manner of the fifth aspect, in a fifteenth possible implementation manner, if a cell handover is performed on the UE, and a third access network identifier has already been allocated to the UE, the identification information received by the receiver includes the third access network identifier, where the third access network identifier includes an identifier allocated to the UE by a network device in another cell except a cell in which the network device is located. The processor is further configured to: before allocating the first access network identifier to the UE according to the identification information, determine whether the third access network identifier is used. The transmitter is further configured to send the first access network identifier to the UE in different manners according to different determining results of the third access network identifier.

According to the fifteenth possible implementation manner of the fifth aspect, in a sixteenth possible implementation manner, the processor is further configured to: if the third access network identifier is used, schedule a downlink channel resource by using an RA-RNTI corresponding to a time-frequency location of the uplink channel resource. The transmitter is further configured to send the first access network identifier to the UE by using the downlink channel resource.

According to the fifteenth possible implementation manner of the fifth aspect, in a seventeenth possible implementation manner, the processor is further configured to: if the third access network identifier is not used, schedule a downlink channel resource by using the third access network identifier. The transmitter is further configured to send the first access network identifier to the UE by using the downlink channel resource.

According to a sixth aspect, an embodiment of the present invention further provides UE, including a receiver, a processor, and a transmitter, where the receiver, the processor, and the transmitter are successively connected. The transmitter is configured to send identification information to a network device according to an access status. The receiver is configured to receive a first access network identifier sent by the network device, where the first access network identifier is an access network identifier allocated by the network device to the UE according to the identification information, and the first access network identifier is used for the network device to allocate a resource to the UE.

According to the sixth aspect, in a first possible implementation manner of the sixth aspect, the transmitter is further configured to send the identification information to the network device according to the access status by using an uplink channel resource.

According to the first possible implementation manner of the sixth aspect, in a second possible implementation manner, the uplink channel resource includes a time-frequency resource used for random access.

According to the first or the second possible implementation manner of the sixth aspect, in a third possible implementation manner, the transmitter is further configured to send BSR information to the network device by using the uplink channel resource, where the BSR information is used for the network device to allocate the first access network identifier to the UE with reference to the identification information, and the BSR information includes a size of to-be-sent data of the UE.

According to any one of the first to the third possible implementation manners of the sixth aspect, in a fourth possible implementation manner, the transmitter is further configured to send connection establishment cause information to the network device by using the uplink channel resource.

According to any one of the sixth aspect to the fourth possible implementation manner of the sixth aspect, in a fifth possible implementation manner, the first access network identifier received by the receiver includes a C-RNTI.

According to any one of the sixth aspect to the fifth possible implementation manner of the sixth aspect, in a sixth possible implementation manner, the receiver is further configured to: receive the first access network identifier and the identification information that are sent by the network device by using the PDSCH, and send the PDSCH and the identification information to the processor; and the processor is further configured to determine the first access network identifier from the PDSCH according to the identification information.

According to the sixth possible implementation manner of the sixth aspect, in a seventh possible implementation manner, the receiver is further configured to: before the processor determines the first access network identifier from the PDSCH according to the identification information, receive scheduling information that is of the PDSCH and is sent by the network device by using DCI, and send the scheduling information to the processor, where the scheduling information includes a time-frequency resource location corresponding to the UE; and the processor is further configured to determine the first access network identifier from the PDSCH according to the identification information and the time-frequency resource location corresponding to the UE.

According to any one of the sixth aspect to the seventh possible implementation manner of the sixth aspect, in an eighth possible implementation manner, if no access network identifier or core network identifier is allocated to the UE, or an identifier already allocated to the UE is invalid, the identification information includes a string of random numbers selected by the UE.

According to any one of the sixth aspect to the seventh possible implementation manner of the sixth aspect, in a ninth possible implementation manner, if the UE is in an idle state, and a core network identifier has already been allocated to the UE, the identification information includes the core network identifier of the UE.

According to the ninth possible implementation manner of the sixth aspect, in a tenth possible implementation manner, the core network identifier of the UE includes a temporary mobile subscriber identity allocated by an MME to the UE.

According to any one of the sixth aspect to the fifth possible implementation manner of the sixth aspect, in an eleventh possible implementation manner, if a second access network identifier has already been allocated to the UE, and the second access network identifier is not used, the identification information includes the second access network identifier, where the second access network identifier is a C-RNTI.

According to the eleventh possible implementation manner of the sixth aspect, in a twelfth possible implementation manner, the receiver is further configured to receive the first access network identifier and the second access network identifier that are sent by the network device by using a downlink channel resource scheduled by using an RA-RNTI corresponding to a time-frequency location of the uplink channel resource.

According to the eleventh possible implementation manner of the sixth aspect, in a thirteenth possible implementation manner, the receiver is further configured to receive the first access network identifier sent by the network device by using a downlink channel resource scheduled by using the second access network identifier.

According to any one of the sixth aspect to the fifth possible implementation manner of the sixth aspect, in a fourteenth possible implementation manner, if a cell handover is performed on the UE, and a third access network identifier has already been allocated to the UE, the identification information includes the third access network identifier, where the third access network identifier includes an identifier allocated to the UE by a network device in another cell except a cell in which the network device is located; and the receiver is further configured to receive the first access network identifier sent by the network device in different manners according to different determining results of the third access network identifier.

According to the fourteenth possible implementation manner of the sixth aspect, in a fifteenth possible implementation manner, the receiver is further configured to receive the first access network identifier sent, when the third access network identifier is used, by the network device by using a downlink channel resource scheduled by using an RA-RNTI corresponding to a time-frequency location of the uplink channel resource.

According to the fourteenth possible implementation manner of the sixth aspect, in a sixteenth possible implementation manner, the receiver is further configured to receive the first access network identifier sent, when the third access network identifier is not used, by the network device by using a downlink channel resource scheduled by using the third access network identifier.

According to the random access method, the network device, and the user equipment in the embodiments of the present invention, the network device only needs to allocate a first access network identifier to UE according to received identification information sent by the UE according to an access status, send the first access network identifier to the UE, and then allocate a resource to the UE according to the first access network identifier, so that resources used for accessing the network device by the UE can be reduced, and signaling overheads can be reduced.

### BRIEF DESCRIPTION OF THE DRAWINGS

To describe the technical solutions in the embodiments of the present invention more clearly, the following briefly describes the accompanying drawings required for describing the embodiments or the prior art. Apparently, the accompanying drawings in the following description show some embodiments of the present invention, and persons of ordinary skill in the art may still derive other drawings from these accompanying drawings without creative efforts.

FIG. 1 is a flowchart of a random access method according to Embodiment 1 of the present invention;

FIG. 2 is a flowchart of a random access method according to Embodiment 2 of the present invention;

FIG. 3 is a flowchart of a random access method according to Embodiment 3 of the present invention;

FIG. 4 is a flowchart of a random access method according to Embodiment 4 of the present invention;

FIG. 5 is a flowchart of a random access method according to Embodiment 5 of the present invention;

FIG. 6 is a flowchart of a random access method according to Embodiment 6 of the present invention;

FIG. 7 is a flowchart of another random access method according to Embodiment 6 of the present invention;

FIG. 8 is a flowchart of still another random access method according to Embodiment 6 of the present invention;

FIG. 9 is a schematic structural diagram of a network device according to Embodiment 7 of the present invention;

FIG. 10 is a schematic structural diagram of UE according to Embodiment 8 of the present invention;

FIG. 11 is a schematic structural diagram of a network device according to Embodiment 9 of the present invention; and

FIG. 12 is a schematic structural diagram of UE according to Embodiment 10 of the present invention.

### DETAILED DESCRIPTION OF ILLUSTRATIVE EMBODIMENTS

The embodiments of the invention are described below with reference to the accompanying drawings.

### Embodiment 1

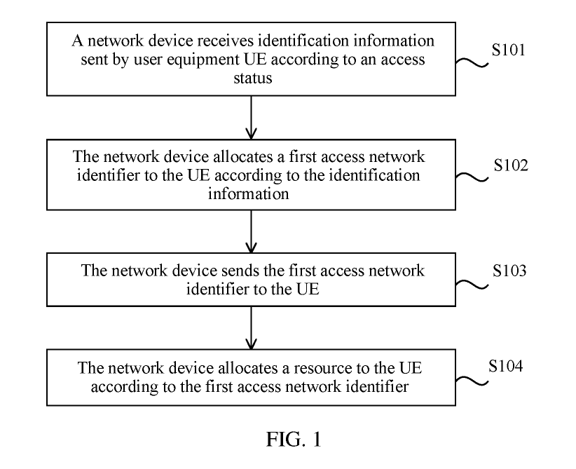

FIG. 1 is a flowchart of a random access method according to Embodiment 1 of the present invention. The method may be applied to a scenario, for example, in which user equipment (UE) initially accesses a network, a connection is interrupted and user equipment accesses a network again, user equipment has accessed a network but there is no uplink channel resource, and the user equipment accesses the network again to apply for a resource, or a cell handover is performed or a base station is reselected. The method may be executed by a network device. The network device may be an access network device such as a base station. As shown in FIG. 1, the method specifically includes the following steps.

Step 101: The network device receives identification information sent by user equipment UE according to an access status.

Specifically, UE has different access statuses in different application scenarios, and UE in different access statuses has different identification information.

Step 102: The network device allocates a first access network identifier to the UE according to the identification information.

The first access network identifier may be identification information that is allocated by the network device and that is required by the UE to access a network, transmit uplink information, or receive downlink information sent by the network device. That the network device allocates the first access network identifier to the UE according to the identification information is actually allocating a resource corresponding to the first access network identifier to the UE according to the identification information. In the prior art, a network device first needs to receive a preamble sequence sent by UE, and send a random access response message. After receiving the message, the UE sends a radio resource control (RRC) connection request message. In addition, a conflict resolution mechanism is needed to resolve a collision problem caused by selection of a same preamble sequence by different UE. However, in this embodiment solution, the network device does not need to receive a preamble sequence sent by the UE, and does not need to return a response message to the UE, either, that is, the network device may allocate the first access network identifier to the UE directly according to the identification information sent by the UE, and allocate a resource to the UE according to the allocated first access network identifier. Therefore, in this embodiment solution, resources used in a random access process can be reduced, and signaling overheads can be reduced.

Step 103: The network device sends the first access network identifier to the UE.

The network device may send the first access network identifier to the UE by using a downlink physical channel. The downlink physical channel may be, for example, a physical downlink shared channel (PDSCH) or a physical downlink control channel (PDCCH).

Step 104: The network device allocates a resource to the UE according to the first access network identifier.

The resource allocated by the network device to the UE according to the first access network identifier may be an uplink resource of the UE. The uplink resource may be used for the UE to transmit uplink data information or uplink signaling information.

It should be noted that, the network device may further schedule the UE according to the first access network identifier, that is, send downlink data information and/or downlink control information (DCI) to the UE according to the first access network identifier, and receive uplink data information sent by the UE according to the first access network identifier, to schedule the UE.

In the random access method provided in this embodiment, a network device only needs to allocate a first access network identifier to UE according to received identification information sent by the UE according to an access status, send the first access network identifier to the UE, and allocate a resource to the UE according to the allocated first access network identifier, so that resources used for accessing the network device by the UE can be reduced, and signaling overheads can be reduced.

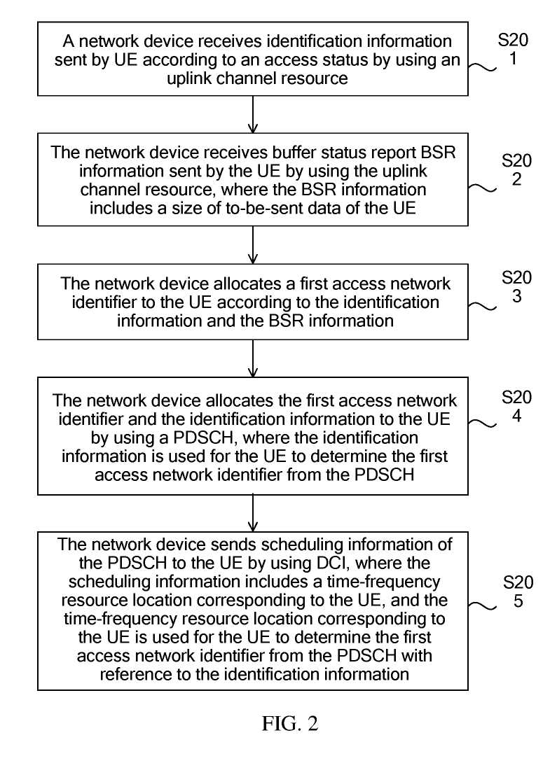

FIG. 2 is a flowchart of a random access method according to Embodiment 2 of the present invention. As shown in FIG. 2, the method is based on the foregoing embodiment. Optionally, the foregoing step 101 in which the network device receives the identification information sent by the UE according to the access status may include the following steps.

Step 201: The network device receives the identification information sent by the UE according to the access status by using an uplink channel resource.

Specifically, the network device may receive the identification information sent by the UE by using any message such as a random access message or a resource request message and by using the uplink channel resource.

Optionally, the uplink channel resource described above may include a time-frequency resource used for random access.

Specifically, if the uplink channel resource includes the time-frequency resource used for random access, the network device may receive the identification information sent by the UE on the corresponding time-frequency resource by using the random access message.

On the basis of the embodiment solution described above, the method further includes the following steps.

Step 202: The network device receives buffer status report BSR information sent by the UE by using the uplink channel resource, where the BSR information includes a size of to-be-sent data of the UE.

Correspondingly, the foregoing step 102 in which the network device allocates the first access network identifier to the UE according to the identification information may include the following steps.

Step 203: The network device allocates the first access network identifier to the UE according to the identification information and the BSR information.

Specifically, the network device further receives the buffer status report (BSR) information sent by the UE by using the uplink channel resource, and the network device allocates the first access network identifier to the UE with reference to the foregoing identification information by using, as reference information, the size that is of the to-be-sent data of the UE and is included in the BSR information. In this embodiment solution, further, the first access network identifier determined by the network device can be more matched to the UE, to ensure proper resource allocation.

Further, the method further includes: receiving, by the network device, connection establishment cause information sent by the UE by using the uplink channel resource.

Specifically, the connection establishment cause information may be, for example, a trigger condition for the random access method, that is, a trigger condition for sending the identification information to the network device by the UE by using the uplink channel resource. The trigger condition may be a UE trigger or a network device trigger. If the trigger condition is the network device trigger, the network device further sends a connection establishment request message and the like to the UE before receiving the identification information sent by the UE by using the uplink channel resource, to trigger the UE to send the identification information.

It should be noted that the identification information, the BSR information, and the connection establishment cause information are all sent by using the uplink channel resource. That is, step 201, step 202, and a step of sending the connection establishment cause information may be performed synchronously. If the uplink channel resource includes the time-frequency resource used for random access, that is, the network device may receive the identification information sent by the UE on the corresponding time-frequency resource by using the random access message, the random access message further includes at least the BSR information and the connection establishment cause information.

Optionally, the first access network identifier described in the foregoing solution includes a cell radio network temporary identifier (C-RNTI).

Further, in the foregoing solution, step 103 in which the network device sends the first access network identifier to the UE includes the following steps.

Step 204: The network device sends the first access network identifier and the identification information to the UE by using a PDSCH, where the identification information is used for the UE to determine the first access network identifier from the PDSCH.

On the basis of the foregoing embodiment, further, the method further includes the following steps.

Step 205: The network device sends scheduling information of the PDSCH to the UE by using DCI, where the scheduling information includes a time-frequency resource location corresponding to the UE, and the time-frequency resource location corresponding to the UE is used for the UE to determine the first access network identifier from the PDSCH with reference to the identification information.

Specifically, the time-frequency resource location corresponding to the UE that is included in the scheduling information refers to a time-frequency resource location that is in the PDSCH and that is for sending information corresponding to the UE, for example, the first access network identifier and the identification information. The network device further sends the scheduling information to the UE, so that the UE determines the information corresponding to the UE from the PDSCH according to the scheduling information, and then determines the first access network identifier according to the identification information. In this embodiment solution, the network device further sends the identification information and the scheduling information to the UE, so that uniqueness of the access network identifier that is allocated by the network device and received by the UE is ensured, thereby avoiding a conflict problem or collision problem of access network identifiers of different UE.

It should be noted that in this embodiment solution, there is no absolute time sequence between step 204 and step 205, and step 205 and step 204 may be performed simultaneously, or step 205 may be performed before or after step 204. This is not limited herein in the present invention.

In the solution described in any one of the foregoing embodiments, if no access network identifier or core network identifier is allocated to the UE, or an identifier already allocated to the UE is invalid, the identification information includes a string of random numbers selected by the UE.

Specifically, if no access network identifier or core network identifier is allocated to the UE, the UE may be in a scenario of initially accessing a network. If the identifier already allocated to the UE is invalid, the UE may be in a scenario of performing a cell handover or reselecting a base station. The string of random numbers selected by the UE may be a character string that includes random numbers of a preset bit quantity, for example, a character string that includes random numbers of 40 bits.

Alternatively, in the foregoing solution, if the UE is in an idle state, and a core network identifier has already been allocated to the UE, the identification information includes the core network identifier of the UE.

Specifically, if the UE is in the idle state, a connection between the UE and an access network may be interrupted, and the UE needs to access the access network again. However, because the UE has registered with a core network, the core network identifier has already been allocated to the UE.

Optionally, the foregoing core network identifier of the UE may include a temporary mobile subscriber identity (TMSI) allocated by a core network device such as a mobility management entity (MME) to the UE.

In the random access method provided in this embodiment, identification information and a time-frequency resource location corresponding to the UE are further sent to UE when a first access network identifier is being sent to the UE, so that a conflict problem or collision problem of access network identifiers received by different UE can be avoided. In addition, identification information corresponding to two access statuses of the UE is further described by using examples to ensure applicability of the solution to different scenarios.

### Embodiment 3

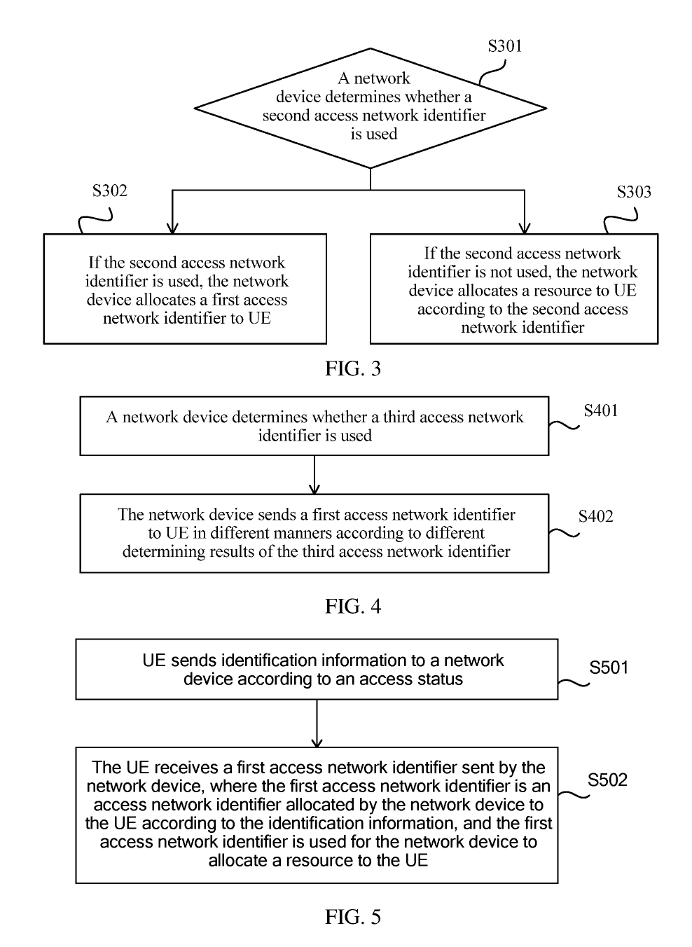

This embodiment of the present invention further provides a random access method. FIG. 3 is a flowchart of the random access method according to Embodiment 3 of the present invention.

The method is based on Embodiment 1 or Embodiment 2. Alternatively, if a second access network identifier has already been allocated to the UE, the identification information includes the second access network identifier. The second access network identifier is a C-RNTI.

Specifically, if the second access network identifier has already been allocated to the UE, that is, the UE is in a connected state, that is, if the UE has accessed a network but there is no uplink channel resource, the UE needs to access the network again to apply for a resource.

As shown in FIG. 3, before the foregoing step 102 in which the network device allocates the first access network identifier to the UE according to the identification information, the method further includes the following steps.

Step 301: The network device determines whether the second access network identifier is used.

Specifically, that the network device determines whether the second access network identifier is used may be, for example, performing retrieval in a resource allocation list stored on the network device, to determine whether the second access network identifier is used. If the network device can retrieve the second access network identifier from the resource allocation list, it indicates that the network device has allocated a resource for the second access network identifier, that is, the second access network identifier is used by other UE. If the network device cannot retrieve the second access network identifier from the resource allocation list, it indicates that the network device has not allocated a resource for the second access network identifier, and therefore, the second access network identifier is not used.

Correspondingly, the foregoing step 102 in which the network device allocates the first access network identifier to the UE according to the identification information may include:

Step 302: If the second access network identifier is used, the network device allocates the first access network identifier to the UE.

Further, in the foregoing embodiment solution, step 103 in which the network device sends the first access network identifier to the UE may include scheduling, by the network device, a downlink channel resource by using a random access radio network temporary identifier (RA-RNTI) corresponding to a time-frequency location of the uplink channel resource, and sending the first access network identifier and the second access network identifier to the UE by using the downlink channel resource.

Alternatively, in the foregoing solution, step 103 in which the network device sends the first access network identifier to the UE may include scheduling, by the network device, a downlink channel resource by using the second access network identifier, and sending the first access network identifier to the UE by using the downlink channel resource.

Optionally, the method further includes the following steps.

Step 303: If the second access network identifier is not used, the network device allocates a resource to the UE according to the second access network identifier.

That is, if the second access network identifier is not used, that is, the second access network identifier is valid, the network device does not need to reallocate an access network identifier to the UE, and only needs to allocate a resource to the UE and schedule the UE directly according to the second access network identifier.

This embodiment further provides a random access method. An allocated second access network identifier of the UE is determined, and then, if the second access network identifier is used, an access network identifier is reallocated to the UE, or if the second access network identifier is not used, the UE is scheduled directly according to the second access network identifier. Multiple implementation solutions used in multiple application scenarios are provided to ensure applicability of the random access method to different scenarios.

### Embodiment 4

This embodiment of the present invention further provides a random access method. FIG. 4 is a flowchart of the random access method according to Embodiment 4 of the present invention.

The method is based on Embodiment 1 or Embodiment 2. Alternatively, if a cell handover is performed on the UE, and a third access network identifier has already been allocated to the UE, the identification information includes the third access network identifier. The third access network identifier includes an identifier allocated to the UE by a network device in another cell except a cell in which the network device is located.

As shown in FIG. 4, before the foregoing step 101 in which the network device allocates the first access network identifier to the UE according to the identification information, the method further includes the following steps.

Step 401: The network device determines whether the third access network identifier is used.

Correspondingly, in the foregoing embodiment solution, step 103 in which the network device sends the first access network identifier to the UE includes the following steps.

Step 402: The network device sends the first access network identifier to the UE in different manners according to different determining results of the third access network identifier.

Specifically, if a cell handover is performed on the UE, regardless of whether the third access network identifier is used, the network device needs to reallocate the first access network identifier to the UE. A difference lies only in that manners of sending, by the network device, the first access network identifier to the UE are different.

Further, in the embodiment solution described above, step 402 in which the network device sends the first access network identifier to the UE in the different manners according to the different determining results of the third access network identifier may include: if the third access network identifier is used, scheduling, by the network device, a downlink channel resource by using an RA-RNTI corresponding to a time-frequency location of the uplink channel resource, and sending the first access network identifier to the UE by using the downlink channel resource.

Optionally, in the foregoing embodiment solution, step 402 in which the network device sends the first access network identifier to the UE in the different manners according to the different determining results of the third access network identifier specifically includes: if the third access network identifier is not used, scheduling, by the network device, a downlink channel resource by using the third access network identifier, and sending the first access network identifier to the UE by using the downlink channel resource.

In the random access method provided in this embodiment, an allocated third access network identifier possessed by UE on which a cell handover is performed is determined, and then, a first access network identifier that is allocated by a network device to the UE is sent to the UE in different manners according to different determining results. Multiple implementation solutions are further provided to better ensure applicability of the random access method to different scenarios.

### Embodiment 5

Embodiment 5 provides a random access method. The method may be executed by UE. FIG. 5 is a flowchart of the random access method according to Embodiment 5 of the present invention. As shown in FIG. 5, the method may specifically include the following steps.

Step 501: The UE sends identification information to a network device according to an access status.

Step 502: The UE receives a first access network identifier sent by the network device, where the first access network identifier is an access network identifier allocated by the network device to the UE according to the identification information, and the first access network identifier is used for the network device to allocate a resource to the UE.

Optionally, the foregoing step 501 in which the UE sends the identification information to the network device according to the access status may include: sending, by the UE, the identification information to the network device according to the access status by using an uplink channel resource.

Further, in the foregoing solution, the uplink channel resource includes a time-frequency resource used for random access.

Further, the method may further include: sending, by the UE, BSR information to the network device by using the uplink channel resource, where the BSR information is used for the network device to allocate the first access network identifier to the UE with reference to the identification information.

The BSR information includes a size of to-be-sent data of the UE.

Optionally, the method may further include: sending, by the UE, connection establishment cause information to the network device by using the uplink channel resource.

Optionally, the first access network identifier includes a C-RNTI.

Alternatively, in the foregoing solution, step 502 in which the UE receives the first access network identifier sent by the network device may include: receiving, by the UE, the first access network identifier and the identification information that are sent by the network device by using the PDSCH; and determining, by the UE, the first access network identifier from the PDSCH according to the identification information.

Further, before the determining, by the UE, the first access network identifier from the PDSCH according to the identification information, the method further includes: receiving, by the UE, scheduling information that is of the PDSCH and is sent by the network device by using DCI, where the scheduling information includes a time-frequency resource location corresponding to the UE.

Correspondingly, the determining, by the UE, the first access network identifier from the PDSCH according to the identification information includes: determining, by the UE, the first access network identifier from the PDSCH according to the identification information and the time-frequency resource location corresponding to the UE.

Optionally, if no access network identifier or core network identifier is allocated to the UE, or an identifier already allocated to the UE is invalid, the identification information includes a string of random numbers selected by the UE.

Alternatively, if the UE is in an idle state, and a core network identifier has already been allocated to the UE, the identification information may include the core network identifier of the UE.

Optionally, the core network identifier of the UE may include a temporary mobile subscriber identity allocated by an MME to the UE.

Alternatively, if a second access network identifier has already been allocated to the UE, and the second access network identifier is not used, the identification information includes the second access network identifier. The second access network identifier is a C-RNTI.

Further, on the basis of the foregoing solution, step 502 in which the UE receives the first access network identifier sent by the network device may include: receiving, by the UE, the first access network identifier and the second access network identifier that are sent by the network device by using a downlink channel resource scheduled by using an RA-RNTI corresponding to a time-frequency location of the uplink channel resource.

Alternatively, step 502 in which the UE receives the first access network identifier sent by the network device may include: receiving, by the UE, the first access network identifier sent by the network device by using a downlink channel resource scheduled by using the second access network identifier.

Optionally, if a cell handover is performed on the UE, and a third access network identifier has already been allocated to the UE, the identification information includes the third access network identifier. The third access network identifier includes an identifier allocated to the UE by a network device in another cell except a cell in which the network device is located.

Correspondingly, step 502 in which the UE receives the first access network identifier sent by the network device may include: receiving, by the UE, the first access network identifier sent by the network device in different manners according to different determining results of the third access network identifier.

Optionally, in the foregoing solution, the receiving, by the UE, the first access network identifier sent by the network device in different manners according to different determining results of the third access network identifier may include: receiving, by the UE, the first access network identifier sent, when the third access network identifier is used, by the network device by using a downlink channel resource scheduled by using an RA-RNTI corresponding to a time-frequency location of the uplink channel resource.

Alternatively, the receiving, by the UE, the first access network identifier sent by the network device in different manners according to different determining results of the third access network identifier may include: receiving, by the UE, the first access network identifier sent, when the third access network identifier is not used, by the network device by using a downlink channel resource scheduled by using the third access network identifier.

The random access method provided in this embodiment of the present invention is a UE-side method corresponding to any one of the random access methods in Embodiment 1 to Embodiment 4. UE sends identification information to a network device according to an access status, and receives a first access network identifier sent by the network device according to the identification information, so that the network device can allocate a resource to the UE directly according to the first access network identifier, and the UE does not need to perform a preamble sequence solution to access the network device. Therefore, resources used for accessing the network device by the UE are reduced, and signaling overheads are reduced.

In addition, in this embodiment of the present invention, the UE may further precisely determine, according to the received identification information and a received time-frequency resource location corresponding to the UE that are sent by the network device, the first access network identifier corresponding to the UE from a PDSCH sent by the network device, so that a problem of a conflict and a collision with access network identifiers received by other UE can be avoided. In addition, the identification information corresponding to multiple access statuses of the UE is further described by using examples to ensure applicability of the solution to different scenarios.

### Embodiment 6

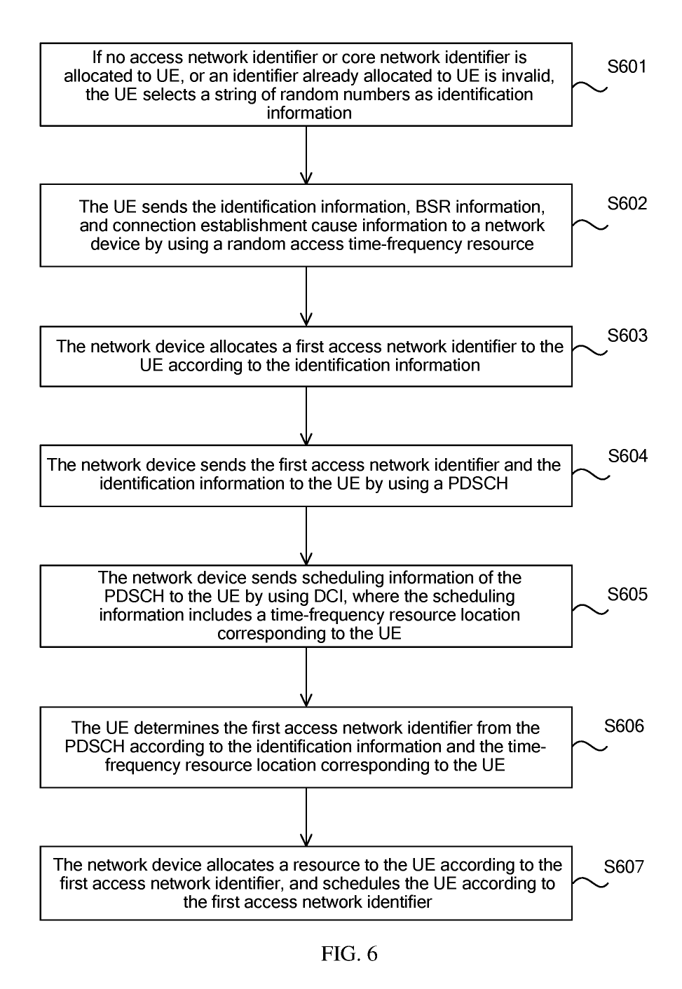

Embodiment 6 of the present invention further provides a random access method. This embodiment provides explanations and descriptions of the foregoing embodiment solution by using a specific instance. FIG. 6 is a flowchart of the random access method according to Embodiment 6 of the present invention. As shown in FIG. 6, the method includes the following steps.

Step 601: If no access network identifier or core network identifier is allocated to UE, or an identifier already allocated to UE is invalid, the UE selects a string of random numbers as identification information.

Step 602: The UE sends the identification information, BSR information, and connection establishment cause information to a network device by using a random access time-frequency resource.

Step 603: The network device allocates a first access network identifier to the UE according to the identification information.

The first access network identifier includes a C-RNTI.

Step 604: The network device sends the first access network identifier and the identification information to the UE by using a PDSCH.

Step 605: The network device sends scheduling information of the PDSCH to the UE by using DCI, where the scheduling information includes a time-frequency resource location corresponding to the UE.

It should be noted that there is no absolute time sequence between step 604 and step 605, and step 604 and step 605 may be performed in sequence or may be performed simultaneously. This is not limited herein.

Step 606: The UE determines the first access network identifier from the PDSCH according to the identification information and the time-frequency resource location corresponding to the UE.

Alternatively, if the UE is in an idle state, and a core network identifier has already been allocated to the UE, only step 601 needs to be adaptively adjusted, and other steps are similar to those in the foregoing solution. The adjusted step may be:

If the UE is in an idle state, and a core network identifier has already been allocated to the UE, the UE uses the core network identifier as the identification information.

Optionally, the core network identifier includes a temporary mobile subscriber identity allocated by an MME to the UE.

Step 607: The network device allocates a resource to the UE according to the first access network identifier, and schedules the UE according to the first access network identifier.

In this embodiment of the present invention, a random access method for accessing a network device by UE is provided, where no access network identifier or core network identifier is allocated to the UE, or an identifier already allocated to the UE is invalid, so that resources used for accessing the network device by the UE can be reduced, where no access network identifier or core network identifier is allocated to the UE, or the identifier already allocated to the UE is invalid.

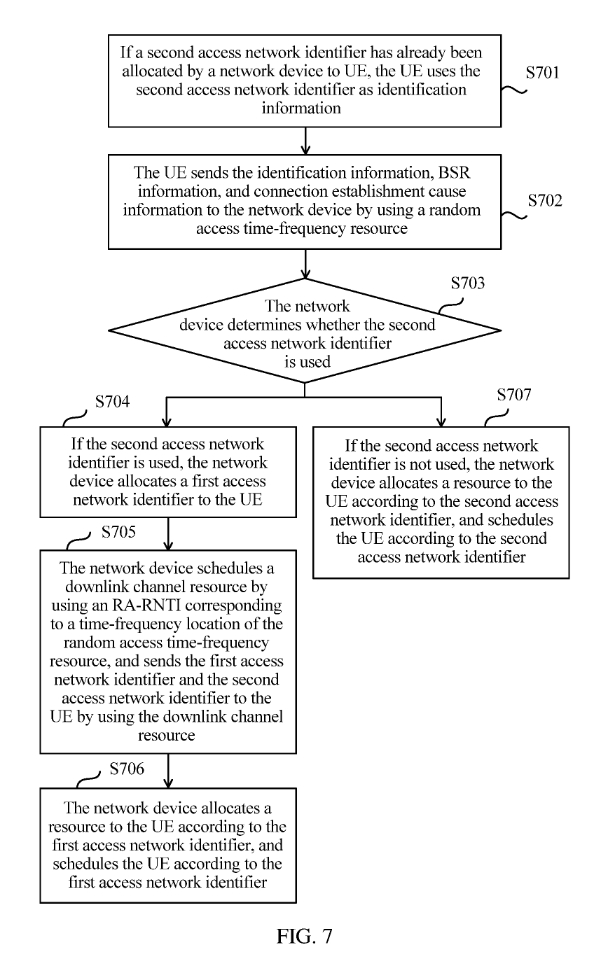

Embodiment 6 further provides another random access method. FIG. 7 is a flowchart of the another random access method according to Embodiment 6 of the present invention. As shown in FIG. 7, the method includes the following steps.

Step 701: If a second access network identifier has already been allocated by a network device to UE, the UE uses the second access network identifier as identification information.

The second access network identifier may be a C-RNTI allocated by the network device before the random access method.

Step 702: The UE sends the identification information, BSR information, and connection establishment cause information to the network device by using a random access time-frequency resource.

Step 703: The network device determines whether the second access network identifier is used.

If the second access network identifier is used, step 704 to step 706 are performed; or if the second access network identifier is not used, step 707 is performed.

Step 704: If the second access network identifier is used, the network device allocates the first access network identifier to the UE.

Step 705: The network device schedules a downlink channel resource by using an RA-RNTI corresponding to a time-frequency location of the random access time-frequency resource, and sends the first access network identifier and the second access network identifier to the UE by using the downlink channel resource.

Alternatively, step 705 in which the network device sends the first access network identifier to the UE may be that the network device schedules a downlink channel resource by using the second access network identifier, and sends the first access network identifier to the UE by using the downlink channel resource.

Step 706: The network device allocates a resource to the UE according to the first access network identifier, and schedules the UE according to the first access network identifier.

Step 707: If the second access network identifier is not used, the network device allocates a resource to the UE according to the second access network identifier, and schedules the UE according to the second access network identifier.

In this embodiment of the present invention, a random access method for accessing a network device by UE to which an access network identifier has already been allocated by the network device may be further provided, so that resources used for accessing the network device by the UE to which the access network identifier has already been allocated by the network device can be reduced.

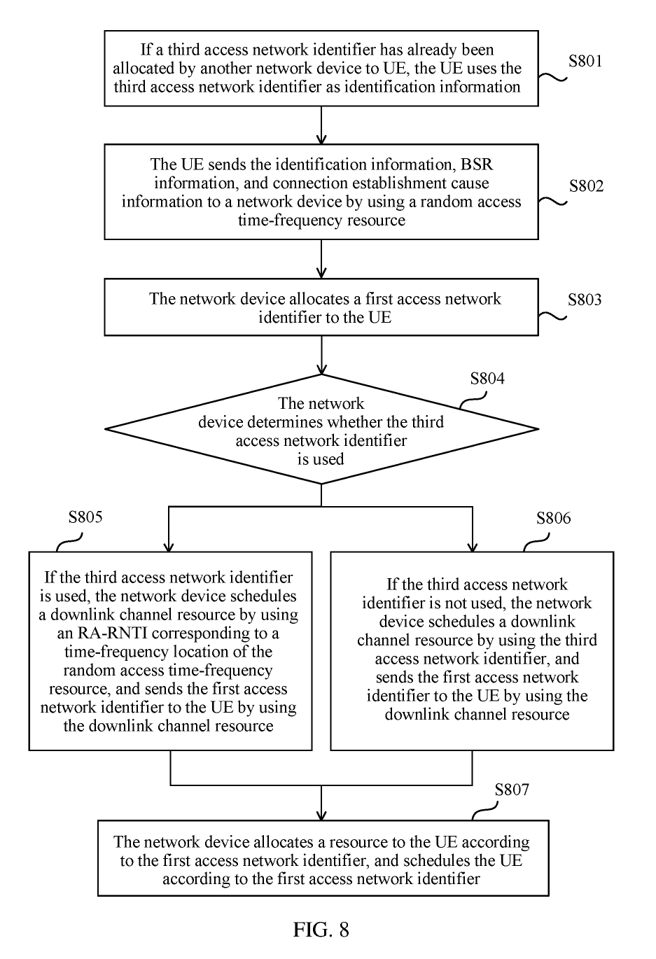

Embodiment 6 further provides another random access method. FIG. 8 is a flowchart of the still another random access method according to Embodiment 6 of the present invention. As shown in FIG. 8, the method may include the following steps.

Step 801: If a third access network identifier has already been allocated by another network device to UE, the UE uses the third access network identifier as identification information.

The third access network identifier may be a C-RNTI allocated before the random access method by the another network device, that is, a network device before a cell handover is performed on the UE.

Step 802: The UE sends the identification information, BSR information, and connection establishment cause information to a network device by using a random access time-frequency resource.

Step 803: The network device allocates the first access network identifier to the UE.

Step 804: The network device determines whether the third access network identifier is used.

If the third access network identifier is used, step 805 and step 807 are performed; or if the third access network identifier is not used, step 806 and step 807 are performed.

It should be noted that the foregoing step 803 and step 804 may be performed simultaneously or may be performed in sequence. This is not limited herein.

Step 805: If the third access network identifier is used, the network device schedules a downlink channel resource by using an RA-RNTI corresponding to a time-frequency location of the random access time-frequency resource, and sends the first access network identifier to the UE by using the downlink channel resource.

Step 806: If the third access network identifier is not used, the network device schedules a downlink channel resource by using the third access network identifier, and sends the first access network identifier to the UE by using the downlink channel resource.

Step 807: The network device allocates a resource to the UE according to the first access network identifier, and schedules the UE according to the first access network identifier.

In this embodiment of the present invention, a random access method for accessing a network device by UE to which an access network identifier has already been allocated by another network device may be further provided, so that resources used for accessing a network device by the UE to which the access network identifier has already been allocated by the another network device can be reduced.

In this embodiment of the present invention, an instance of accessing a network device by UE in multiple access statuses is used to provide explanations and descriptions of the foregoing embodiment solution. Resources used for accessing the network device by the UE in the multiple access statuses can be reduced, and signaling overheads can be reduced.

### Embodiment 7

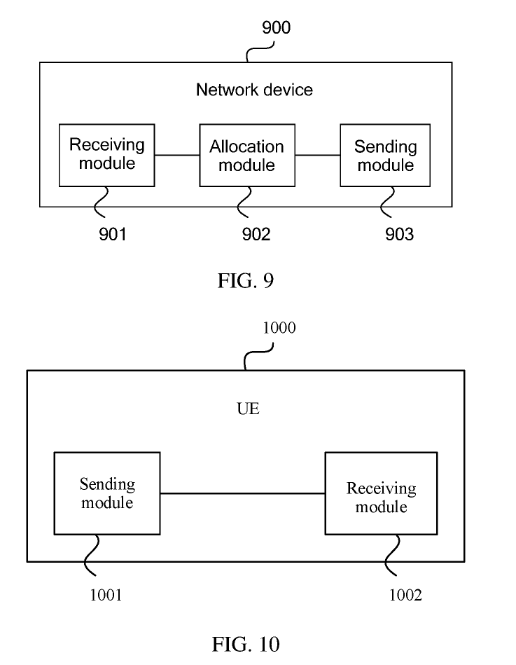

Embodiment 7 of the present invention further provides a network device. The network device provided in Embodiment 7 of the present invention may execute any one of the random access methods provided in Embodiment 1 to Embodiment 4. FIG. 9 is a schematic structural diagram of the network device according to Embodiment 7 of the present invention.

As shown in FIG. 9, a network device 900 includes a receiving module 901, an allocation module 902, and a sending module 903. The receiving module 901, the allocation module 902, and the sending module 903 are successively connected.

The receiving module 901 is configured to: receive identification information sent by UE according to an access status, and send the identification information to the allocation module 902.

The allocation module 902 is configured to: allocate a first access network identifier to the UE according to the identification information, and send the first access network identifier to the sending module 903.

The sending module 903 is configured to send the first access network identifier to the UE.

The allocation module 902 is further configured to allocate a resource to the UE according to the first access network identifier.

Optionally, the receiving module 901 is further configured to receive the identification information sent by the UE according to the access status by using an uplink channel resource.

Further, the uplink channel resource includes a time-frequency resource used for random access.

Further, the receiving module 901 is further configured to: receive BSR information sent by the UE by using the uplink channel resource, and send the BSR information to the allocation module 902. The BSR information includes a size of to-be-sent data of the UE.

Correspondingly, the allocation module 902 is further configured to allocate the first access network identifier to the UE according to the identification information and the BSR information.

On the basis of any one of the foregoing network devices, the receiving module 901 is further configured to receive connection establishment cause information sent by the UE by using the uplink channel resource.

Optionally, the foregoing first access network identifier includes a C-RNTI.

In the foregoing network device, the sending module 903 is further configured to send the first access network identifier and the identification information to the UE by using a PDSCH. The identification information is used for the UE to determine the first access network identifier from the PDSCH.

Further, the sending module 903 is further configured to send scheduling information of the PDSCH to the UE by using DCI. The scheduling information includes a time-frequency resource location corresponding to the UE, and the time-frequency resource location corresponding to the UE is used for the UE to determine the first access network identifier from the PDSCH with reference to the identification information.

On the basis of any one of the foregoing network devices, further, if no access network identifier or core network identifier is allocated to the UE, or an identifier already allocated to the UE is invalid, the identification information received by the receiving module 901 includes a string of random numbers selected by the UE.

Alternatively, if the UE is in an idle state, and a core network identifier has already been allocated to the UE, the identification information received by the receiving module 901 includes the core network identifier of the UE.

Optionally, the foregoing core network identifier of the UE includes a temporary mobile subscriber identity allocated by an MME to the UE.

Alternatively, if a second access network identifier has already been allocated to the UE, the identification information received by the receiving module 901 includes the second access network identifier. The second access network identifier is a C-RNTI.

The network device 900 further includes a first determining module, and the first determining module is connected to the receiving module 901 and the allocation module 902.

The first determining module is configured to: before the allocation module 902 allocates the first access network identifier to the UE according to the identification information, determine whether the second access network identifier is used, and send a determining result of the second access network identifier to the allocation module 902.

Correspondingly, the allocation module 902 is further configured to: if the second access network identifier is used, allocate the first access network identifier to the UE.

Further, the network device 900 further includes a first scheduling module, and the first scheduling module is connected to the allocation module 902 and the sending module 903.

The first scheduling module is configured to schedule a downlink channel resource by using an RA-RNTI corresponding to a time-frequency location of the uplink channel resource.

The sending module 903 is further configured to send the first access network identifier and the second access network identifier to the UE by using the downlink channel resource.

Alternatively, the network device 900 further includes a second scheduling module, and the second scheduling module is connected to the allocation module 902 and the sending module 903.

The second scheduling module is configured to schedule a downlink channel resource by using the second access network identifier.

The sending module 903 is further configured to send the first access network identifier to the UE by using the downlink channel resource.

Optionally, the allocation module 902 is further configured to: if the second access network identifier is not used, allocate a resource to the UE according to the second access network identifier.

Alternatively, if a cell handover is performed on the UE, and a third access network identifier has already been allocated to the UE, the identification information received by the receiving module 901 includes the third access network identifier. The third access network identifier includes an identifier allocated to the UE by a network device in another cell except a cell in which the network device is located.

The network device 900 further includes a second determining module, and the second determining module is connected to the receiving module 901 and the allocation module 902.

The second determining module is configured to: before the allocation module 902 allocates the first access network identifier to the UE according to the identification information, determine whether the third access network identifier is used, and send a determining result of the third access network identifier to the allocation module 902.

Correspondingly, the sending module 903 is further configured to send the first access network identifier to the UE in different manners according to different determining results of the third access network identifier.

Optionally, the network device 900 further includes a third scheduling module, and the third scheduling module is connected to the allocation module 902 and the sending module 903.

The third scheduling module is configured to: if the third access network identifier is used, schedule a downlink channel resource by using an RA-RNTI corresponding to a time-frequency location of the uplink channel resource.

The sending module 903 is further configured to send the first access network identifier to the UE by using the downlink channel resource.

Alternatively, the network device 900 further includes a fourth scheduling module, and the fourth scheduling module is connected to the allocation module 902 and the sending module 903.

The fourth scheduling module is configured to: if the third access network identifier is not used, schedule a downlink channel resource by using the third access network identifier.

The sending module 903 is further configured to send the first access network identifier to the UE by using the downlink channel resource.

The network device provided in this embodiment of the present invention may execute any one of the random access methods in Embodiment 1 to Embodiment 4. The network device only needs to allocate a first access network identifier to UE according to received identification information sent by the UE according to an access status, send the first access network identifier to the UE, and allocate a resource to the UE according to the allocated first access network identifier, so that resources used for accessing the network device by the UE can be reduced, and signaling overheads can be reduced.

### Embodiment 8

Embodiment 8 of the present invention further provides UE. The UE provided in Embodiment 8 of the present invention may execute the random access method provided in Embodiment 5. FIG. 10 is a schematic structural diagram of the UE according to Embodiment 8 of the present invention.

As shown in FIG. 10, a UE 1000 includes a sending module 1001 and a receiving module 1002. The sending module 1001 and the receiving module 1002 are connected. Both the sending module 1001 and the receiving module 1002 are connected to a network device.

The sending module 1001 is configured to send identification information to the network device according to an access status.

The receiving module 1002 is configured to receive a first access network identifier sent by the network device. The first access network identifier is an access network identifier allocated by the network device to the UE according to the identification information, and the first access network identifier is used for the network device to allocate a resource to the UE.

Further, the sending module 1001 is further configured to send the identification information to the network device according to the access status by using an uplink channel resource.

Optionally, the uplink channel resource includes a time-frequency resource used for random access.

Optionally, the sending module 1001 is further configured to send BSR information to the network device by using the uplink channel resource. The BSR information is used for the network device to allocate the first access network identifier to the UE with reference to the identification information. The BSR information includes a size of to-be-sent data of the UE.

Further, the sending module 1001 is further configured to send connection establishment cause information to the network device by using the uplink channel resource.

Optionally, the first access network identifier received by the foregoing receiving module 1002 includes a C-RNTI.

In the UE described above, the UE 1000 further includes a determining module, and the determining module and the receiving module 1002 are connected.

The receiving module 1002 is further configured to: receive the first access network identifier and the identification information that are sent by the network device by using the PDSCH, and send the PDSCH and the identification information to the determining module.

The determining module is configured to determine the first access network identifier from the PDSCH according to the identification information.

Optionally, the receiving module 1002 is further configured to: before the determining module determines the first access network identifier from the PDSCH, receive scheduling information that is of the PDSCH and is sent by the network device by using DCI, and send the scheduling information to the determining module. The scheduling information includes a time-frequency resource location corresponding to the UE.

The determining module is further configured to determine the first access network identifier from the PDSCH according to the identification information and the time-frequency resource location corresponding to the UE.

Further, if no access network identifier or core network identifier is allocated to the UE, or an identifier already allocated to the UE is invalid, the identification information includes a string of random numbers selected by the UE.

Alternatively, if the UE is in an idle state, and a core network identifier has already been allocated to the UE, the identification information includes the core network identifier of the UE.

Optionally, the core network identifier of the UE includes a temporary mobile subscriber identity allocated by an MME to the UE.

Alternatively, if a second access network identifier has already been allocated to the UE, and the second access network identifier is not used, the identification information includes the second access network identifier. The second access network identifier is a C-RNTI.

Further, the receiving module 1002 is further configured to receive the first access network identifier and the second access network identifier that are sent by the network device by using a downlink channel resource scheduled by using an RA-RNTI corresponding to a time-frequency location of the uplink channel resource.

Alternatively, the receiving module 1002 is further configured to receive the first access network identifier sent by the network device by using a downlink channel resource scheduled by using the second access network identifier.

Alternatively, if a cell handover is performed on the UE, and a third access network identifier has already been allocated to the UE, the identification information includes the third access network identifier. The third access network identifier includes an identifier allocated to the UE by a network device in another cell except a cell in which the network device is located.

The receiving module 1002 is further configured to receive the first access network identifier sent by the network device in different manners according to different determining results of the third access network identifier.

Optionally, the receiving module 1002 is further configured to receive the first access network identifier sent, when the third access network identifier is used, by the network device by using a downlink channel resource scheduled by using an RA-RNTI corresponding to a time-frequency location of the uplink channel resource.

Alternatively, the receiving module 1002 is further configured to receive the first access network identifier sent, when the third access network identifier is not used, by the network device by using a downlink channel resource scheduled by using the third access network identifier.

The UE provided in this embodiment of the present invention may execute the random access method, provided in Embodiment 5, executed by UE. The UE may send identification information to a network device according to an access status, and receive a first access network identifier sent by the network device according to the identification information, so that the network device can allocate a resource to the UE directly according to the first access network identifier, and the UE does not need to perform a preamble sequence solution to access the network device. Therefore, resources used for accessing the network device by the UE are reduced, and signaling overheads are reduced.

### Embodiment 9

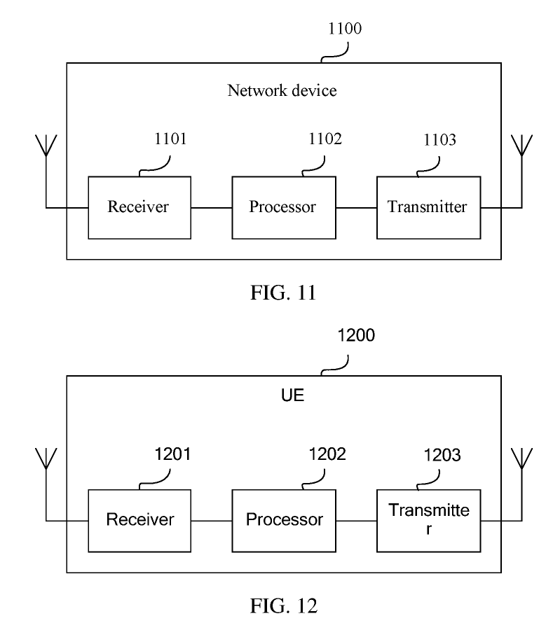

Embodiment 9 of the present invention further provides a network device. The network device provided in Embodiment 9 of the present invention may execute any one of the random access methods provided in Embodiment 1 to Embodiment 4. FIG. 11 is a schematic structural diagram of the network device according to Embodiment 9 of the present invention.

As shown in FIG. 11, the network device 1100 includes a receiver 1101, a processor 1102, and a transmitter 1103. The receiver 1101, the processor 1102, and the transmitter 1103 are successively connected.

The receiver 1101 is configured to: receive identification information sent by UE according to an access status, and send the identification information to the processor 1102.

The processor 1102 is configured to: allocate a first access network identifier to the UE according to the identification information, and send the first access network identifier to the transmitter 1103.

The transmitter 1103 is configured to send the first access network identifier to the UE.

The processor 1102 is further configured to allocate a resource to the UE according to the first access network identifier.

Further, the foregoing receiver 1101 is further configured to receive the identification information sent by the UE according to the access status by using an uplink channel resource.

Optionally, the uplink channel resource includes a time-frequency resource used for random access.

Optionally, the receiver 1101 is further configured to: receive BSR information sent by the UE by using the uplink channel resource, and send the BSR information to the processor 1102. The BSR information includes a size of to-be-sent data of the UE.

Correspondingly, the processor 1102 is further configured to allocate the first access network identifier to the UE according to the identification information and the BSR information.

Further, the receiver 1101 is further configured to receive connection establishment cause information sent by the UE by using the uplink channel resource.

Optionally, in the network device described above, the first access network identifier includes a C-RNTI.

Optionally, the transmitter 1103 is further configured to send the first access network identifier and the identification information to the UE by using a PDSCH. The identification information is used for the UE to determine the first access network identifier from the PDSCH.

Optionally, the transmitter 1103 is further configured to send scheduling information of the PDSCH to the UE by using DCI. The scheduling information includes a time-frequency resource location corresponding to the UE, and the time-frequency resource location corresponding to the UE is used for the UE to determine the first access network identifier from the PDSCH with reference to the identification information.

Further, if no access network identifier or core network identifier is allocated to the UE, or an identifier already allocated to the UE is invalid, the identification information received by the receiver 1101 includes a string of random numbers selected by the UE.

Alternatively, if the UE is in an idle state, and a core network identifier has already been allocated to the UE, the identification information received by the receiver 1101 includes the core network identifier of the UE.

Optionally, the core network identifier of the UE includes a temporary mobile subscriber identity allocated by an MME to the UE.

Alternatively, if a second access network identifier has already been allocated to the UE, the identification information received by the receiver 1101 includes the second access network identifier. The second access network identifier is a C-RNTI.

The processor 1102 is further configured to: before allocating the first access network identifier to the UE according to the identification information, determine whether the second access network identifier is used, and if the second access network identifier is used, allocate the first access network identifier to the UE.

Further, the processor 1102 is further configured to schedule a downlink channel resource by using an RA-RNTI corresponding to a time-frequency location of the uplink channel resource.

The transmitter 1103 is further configured to send the first access network identifier and the second access network identifier to the UE by using the downlink channel resource.

Alternatively, the processor 1102 is further configured to schedule a downlink channel resource by using the second access network identifier.

The transmitter 1103 is further configured to send the first access network identifier to the UE by using the downlink channel resource.

Optionally, the processor 1102 is further configured to: if the second access network identifier is not used, allocate a resource to the UE according to the second access network identifier.

Alternatively, if a cell handover is performed on the UE, and a third access network identifier has already been allocated to the UE, the identification information received by the receiver 1101 includes the third access network identifier. The third access network identifier includes an identifier allocated to the UE by a network device in another cell except a cell in which the network device is located.

The processor 1102 is further configured to: before allocating the first access network identifier to the UE according to the identification information, determine whether the third access network identifier is used.

The transmitter 1103 is further configured to send the first access network identifier to the UE in different manners according to different determining results of the third access network identifier.

Optionally, the processor 1102 is further configured to: if the third access network identifier is used, schedule a downlink channel resource by using an RA-RNTI corresponding to a time-frequency location of the uplink channel resource.

The transmitter 1103 is further configured to send the first access network identifier to the UE by using the downlink channel resource.

Alternatively, the processor 1102 is further configured to: if the third access network identifier is not used, schedule a downlink channel resource by using the third access network identifier.

The transmitter 1103 is further configured to send the first access network identifier to the UE by using the downlink channel resource.

The network device provided in this embodiment of the present invention may execute any one of the random access methods in Embodiment 1 to Embodiment 4. The network device only needs to allocate a first access network identifier to UE according to received identification information sent by the UE according to an access status, send the first access network identifier to the UE, and allocate a resource to the UE according to the allocated first access network identifier, so that resources used for accessing the network device by the UE can be reduced, and signaling overheads can be reduced.

### Embodiment 10

Embodiment 10 of the present invention further provides UE. FIG. 12 is a schematic structural diagram of the UE according to Embodiment 10 of the present invention.

As shown in FIG. 12, the UE 1200 includes a receiver 1201, a processor 1202, and a transmitter 1203. The receiver 1201, the processor 1202, and the transmitter 1203 are successively connected.

The transmitter 1203 is configured to send identification information to a network device according to an access status.

The receiver 1201 is configured to receive a first access network identifier sent by the network device. The first access network identifier is an access network identifier allocated by the network device to the UE according to the identification information, and the first access network identifier is used for the network device to allocate a resource to the UE.

Further, the transmitter 1203 is further configured to send the identification information to the network device according to the access status by using an uplink channel resource.

The uplink channel resource includes a time-frequency resource used for random access.

Optionally, the transmitter 1203 is further configured to send BSR information to the network device by using the uplink channel resource. The BSR information is used for the network device to allocate the first access network identifier to the UE with reference to the identification information. The BSR information includes a size of to-be-sent data of the UE.

Further, the transmitter 1203 is further configured to send connection establishment cause information to the network device by using the uplink channel resource.

In the embodiment solution described above, the first access network identifier received by the receiver 1201 includes a C-RNTI.

Optionally, the receiver 1201 is further configured to: receive the first access network identifier and the identification information that are sent by the network device by using the PDSCH, and send the PDSCH and the identification information to the processor 1202.

The processor 1202 is further configured to determine the first access network identifier from the PDSCH according to the identification information.

Optionally, the receiver 1201 is further configured to: before the processor 1202 determines the first access network identifier from the PDSCH according to the identification information, receive scheduling information that is of the PDSCH and is sent by the network device by using DCI, and send the scheduling information to the processor 1202. The scheduling information includes a time-frequency resource location corresponding to the UE.

The processor 1202 is further configured to determine the first access network identifier from the PDSCH according to the identification information and the time-frequency resource location corresponding to the UE.

Further, if no access network identifier or core network identifier is allocated to the UE, or an identifier already allocated to the UE is invalid, the identification information includes a string of random numbers selected by the UE.

Alternatively, if the UE is in an idle state, and a core network identifier has already been allocated to the UE, the identification information includes the core network identifier of the UE.

Optionally, the core network identifier of the UE includes a temporary mobile subscriber identity allocated by an MME to the UE.

Alternatively, if a second access network identifier has already been allocated to the UE, and the second access network identifier is not used, the identification information includes the second access network identifier. The second access network identifier is a C-RNTI.

Optionally, the receiver 1201 is further configured to receive the first access network identifier and the second access network identifier that are sent by the network device by using a downlink channel resource scheduled by using an RA-RNTI corresponding to a time-frequency location of the uplink channel resource.

Alternatively, the receiver 1201 is further configured to receive the first access network identifier sent by the network device by using a downlink channel resource scheduled by using the second access network identifier.

Alternatively, if a cell handover is performed on the UE, and a third access network identifier has already been allocated to the UE, the identification information includes the third access network identifier. The third access network identifier includes an identifier allocated to the UE by a network device in another cell except a cell in which the network device is located.

The receiver 1201 is further configured to receive the first access network identifier sent by the network device in different manners according to different determining results of the third access network identifier.

Optionally, the receiver 1201 is further configured to receive the first access network identifier sent, when the third access network identifier is used, by the network device by using a downlink channel resource scheduled by using an RA-RNTI corresponding to a time-frequency location of the uplink channel resource.

Alternatively, the receiver 1201 is further configured to receive the first access network identifier sent, when the third access network identifier is not used, by the network device by using a downlink channel resource scheduled by using the third access network identifier.

The UE provided in this embodiment of the present invention may execute any random access method, provided in Embodiment 5, executed by UE. The UE may send identification information to a network device according to an access status, and receive a first access network identifier sent by the network device according to the identification information, so that the network device can allocate a resource to the UE directly according to the first access network identifier, and the UE does not need to perform a preamble sequence solution to access the network device. Therefore, resources used for accessing the network device by the UE are reduced, and signaling overheads are reduced.

Persons of ordinary skill in the art may understand that all or some of the steps of the method embodiments may be implemented by a program instructing relevant hardware. The program may be stored in a computer readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method, comprising:
receiving, by a network device, identification information sent by terminal device according to an access status;
allocating, by the network device, a first access network identifier to the terminal device according to the identification information;
sending, by the network device, the first access network identifier to the terminal device; and
allocating, by the network device, a resource to the terminal device according to the first access network identifier.

2. The method according to claim 1, wherein receiving, by the network device, the identification information sent by the terminal device according to the access status comprises:
receiving, by the network device, the identification information sent by the terminal device according to the access status using an uplink channel resource.

3. The method according to claim 2, wherein the uplink channel resource comprises a time-frequency resource used for random access.

4. The method according to claim 2, further comprising:
receiving, by the network device, buffer status report (BSR) information sent by the terminal device using the uplink channel resource, wherein the BSR information comprises a size of to-be-sent data of the terminal device;
wherein allocating, by the network device, the first access network identifier to the terminal device according to the identification information comprises:
allocating, by the network device, the first access network identifier to the terminal device according to the identification information and the BSR information.

5. The method according to claim 2, further comprising:
receiving, by the network device, connection establishment cause information sent by the terminal device using the uplink channel resource.

6. A method, comprising:
sending, by terminal device, identification information to a network device according to an access status; and
receiving, by the terminal device, a first access network identifier sent by the network device, wherein the first access network identifier is allocated by the network device to the terminal device according to the identification information, and the first access network identifier is used by the network device to allocate a resource to the terminal device.

7. The method according to claim 6, wherein sending, by the terminal device, identification information to the network device according to the access status comprises:
sending, by the terminal device, the identification information to the network device according to the access status using an uplink channel resource.

8. The method according to claim 7, wherein the uplink channel resource comprises a time-frequency resource used for random access.

9. The method according to claim 7, further comprising:
sending, by the terminal device, buffer status report (BSR) information to the network device using the uplink channel resource, wherein the BSR information is used by the network device to allocate the first access network identifier to the terminal device according to the identification information, and the BSR information comprises a size of to-be-sent data of the terminal device.

10. The method according to claim 7, further comprising:
sending, by the terminal device, connection establishment cause information to the network device using the uplink channel resource.

11. A network device, comprising:
a receiver;
a processor; and
a transmitter;
wherein the receiver, the processor, and the transmitter are successively connected;
wherein the receiver is configured to receive identification information sent by a terminal device according to an access status, and to send the identification information to the processor;
wherein the processor is configured to allocate a first access network identifier to the terminal device according to the identification information, and to send the first access network identifier to the transmitter;
wherein the transmitter is configured to send the first access network identifier to the terminal device; and
wherein the processor is further configured to allocate a resource to the terminal device according to the first access network identifier.

12. The network device according to claim 11, wherein the receiver is further configured to receive the identification information sent by the terminal device according to the access status using an uplink channel resource.

13. The network device according to claim 12, wherein the uplink channel resource comprises a time-frequency resource used for random access.

14. The network device according to claim 12, wherein the receiver is further configured to receive buffer status report (BSR) information sent by the terminal device using the uplink channel resource, and to send the BSR information to the processor, wherein the BSR information comprises a size of to-be-sent data of the terminal device; and
wherein the processor is further configured to allocate the first access network identifier to the terminal device according to the identification information and the BSR information.

15. The network device according to claim 12, wherein the receiver is further configured to receive connection establishment cause information sent by the terminal device using the uplink channel resource.

16. A terminal device, comprising:
a receiver;
a processor; and
a transmitter;
wherein the receiver, the processor, and the transmitter are successively connected;
wherein the transmitter is configured to send identification information to a network device according to an access status; and
wherein the receiver is configured to receive a first access network identifier sent by the network device, wherein the first access network identifier is allocated by the network device to the terminal device according to the identification information, and the first access network identifier is used by the network device to allocate a resource to the terminal device.

17. The terminal device according to claim 16, wherein the transmitter is further configured to send the identification information to the network device according to the access status using an uplink channel resource.

18. The terminal device according to claim 17, wherein the uplink channel resource comprises a time-frequency resource used for random access.

19. The terminal device according to claim 17, wherein the transmitter is further configured to send buffer status report (BSR) information to the network device using the uplink channel resource, wherein the BSR information is used by the network device to allocate the first access network identifier to the terminal device according to the identification information, and the BSR information comprises a size of to-be-sent data of the terminal device.

20. The terminal device according to claim 17, wherein the transmitter is further configured to send connection establishment cause information to the network device using the uplink channel resource.
